(19) United States
(12) Patent Application Publication
(10) Pub. No.: US 2026/0042954 A1
(43) Pub. Date: Feb. 12, 2026

(54) CORROSION INHIBITOR COMPOSITIONS AND METHODS OF USING THE SAME

(71) Applicant: ChampionX LLC, Sugar Land, TX (US)

(72) Inventor: Jeremy MOLONEY, Katy, TX (US)

(73) Assignee: ChampionX LLC, Sugar Land, TX (US)

(21) Appl. No.: 18/747,611

(22) Filed: Jun. 19, 2024

Related U.S. Application Data
(60) Provisional application No. 63/509,876, filed on Jun. 23, 2023.

(51) Int. Cl. C09K 8/54; C09D 5/08; C09D 7/20; C09D 7/63; C23F 11/14

(52) U.S. Cl. CPC C09K 8/54; C09D 5/086; C09D 7/20; C09D 7/63; C23F 11/149; C09K 2208/32

(57) ABSTRACT

The disclosure provides a composition including a corrosion inhibitor compound and an iron chelating agent. The composition may be used in a method of inhibiting corrosion of a metal surface. The method includes adding the composition to an aqueous system that includes the metal surface. The composition may be applied to the metal surface, for example, using batch treatment techniques.

### TECHNICAL FIELD

The present disclosure generally relates to corrosion inhibitor compositions and methods of using the compositions to inhibit corrosion. More particularly, the present disclosure relates to corrosion inhibitor compositions comprising an iron chelating agent and methods of using the compositions in, for example, oil and gas production wells and/or pipelines.

### BACKGROUND

Corrosion inhibitors are often added into upstream oil and gas production fluids to protect carbon steel pipelines and infrastructure from corrosion. Oil and gas operators often treat carbon steel pipelines and production tubulars with batch corrosion inhibitor. Such batch corrosion inhibitor products usually contain oil-soluble chemistries and are directly applied to the pipe/tube walls as a slug of chemical between two spheres, sometimes referred to as pigs, to coat the entire circumference of the interior surface of the wall. The directly applied film formed on the metal surface provides a barrier to the water electrolyte to inhibit corrosion. The frequency of reapplication depends on the severity of the operating environment and frequencies. Typical frequencies range from a few times per year, monthly, or even weekly.

While batch corrosion inhibitor treatment is an effective way to film the entire interior surface of the wall, there are a number of limitations including the operator having to choke back production, which leads to loss or deferred production and revenue, health and safety of personnel in handling a large quantity of chemicals, logistics, transportation, and associated costs, and environmental impacts.

### BRIEF SUMMARY

The present disclosure provides methods and compositions for inhibiting corrosion of metallic surfaces. In some embodiments, a method is provided that comprises intermittently applying a composition to a metal surface, wherein the composition comprises a corrosion inhibitor compound and an iron chelating agent.

In some embodiments, a pipeline comprises the metal surface. The method may further comprise reducing a flow rate of a process fluid within the pipeline while applying the composition. In certain embodiments, the flow rate is reduced by about 10% to about 75%.

In some embodiments, the pipeline comprises a lead pig and a filming pig. In such embodiments, the composition is applied to the metal surface between the lead pig and the filming pig. In certain embodiments, an outer diameter of the lead pig is about 3% to about 10% greater than an inner diameter of the pipeline. In certain embodiments, an outer diameter of the filming pig is about 1% to about 5% greater than an inner diameter of the pipeline.

The composition may comprise from, for example, about 0.5 wt. % to about 50 wt. % of the iron chelating agent. The composition may comprise from, for example, about 5 wt. % to about 95 wt. % of the corrosion inhibitor. In certain embodiments, the composition comprises a weight ratio of the corrosion inhibitor to the iron chelating agent of about 0.5:1 to about 50:1.

In some embodiments, the composition is applied directly to the metal surface in the absence of an aqueous medium.

In some embodiments, the composition excludes a divalent metal ion.

In certain embodiments, the composition is applied intermittently at an interval between about once per week and once per year.

In some embodiments, the corrosion inhibitor comprises a quaternary amine compound and/or an imidazoline compound. The imidazoline compound may comprise, for example, formula (I), (II), or (III):

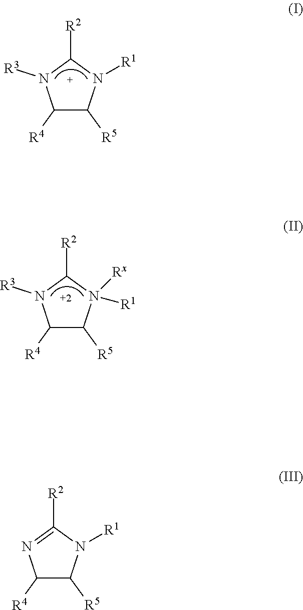

wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³); R² is a radical derived from a fatty acid; R³ and R^{x} are each independently selected from a radical derived from an unsaturated acid; R⁶, R⁷, R⁸, R⁹, R¹⁰, and R¹¹ are each independently, at each occurrence, selected from hydrogen, alkyl, and alkenyl; R¹² and R¹³ are each independently, at each occurrence, selected from hydrogen, alkyl, —COR¹⁴, —CO₂R¹⁵, -alkyl-COR¹⁶, and -alkyl-CO₂R¹⁷; and R¹⁴, R¹⁵, R¹⁶, and R¹⁷ are each independently, at each occurrence, selected from hydrogen, alkyl, and alkenyl.

The quaternary amine compound may be an alkyl quaternary salt, a hydroxyalkyl quaternary salt, an alkylaryl quaternary salt, an arylalkyl quaternary salt or an arylamine quaternary salt.

In some embodiments, the composition further comprises a solvent selected from the group consisting of an alcohol, a hydrocarbon, a ketone, an ether, an aromatic, an amide, a nitrile, a sulfoxide, an ester, a glycol ether, water, and any combination thereof. The composition may comprise from about 5 wt. % to about 95 wt. % of the solvent.

In certain embodiments, the iron chelating agent is selected from the group consisting of nitrilotriacetic acid, tannic acid, ethylenediaminetetraacetic acid (EDTA), diethylenetriaminepentaacetic acid, triethylenetetraminehexaacetic acid, 1-Hydroxyethylidene-1,1-diphosphonic acid (HEDP), and any combination thereof.

In some embodiments, the composition comprises from about 5 wt. % to about 10 wt. % of nitrilotriacetic acid, tannic acid, or a mixture thereof, from about 10 wt. % to about 50 wt. % of a blend comprising about 50% tall oil fatty acid/diethylenetriamine imidazoline, and from about 40 wt. % to about 80 wt. % of xylene.

The foregoing has outlined rather broadly the features and technical advantages of the present disclosure in order that the detailed description that follows may be better understood. Additional features and advantages of the disclosure will be described hereinafter that form the subject of the claims of this application. It should be appreciated by those skilled in the art that the conception and the specific embodiments disclosed may be readily utilized as a basis for modifying or designing other embodiments for carrying out the same purposes of the present disclosure. It should also be realized by those skilled in the art that such equivalent embodiments do not depart from the spirit and scope of the disclosure as set forth in the appended claims.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not strictly limited to those illustrated in the drawings or described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (i.e., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides compositions and methods that can be used in industrial aqueous systems. In some embodiments, the compositions and methods may be used to inhibit corrosion of a metallic surface present in an oil and gas production well and/or pipeline.

The technology disclosed herein effectively enhances corrosion inhibitor performance and leads to film persistency/increased lifetime of the applied film. The technology therefore decreases the frequency of needed batch corrosion inhibitor applications, which reduces cost and chemical usage.

The corrosion inhibitor compositions disclosed herein may comprise a variety of treatment chemicals and/or compounds, such as a corrosion inhibitor compound and an iron chelating agent. In certain embodiments, a composition of the present disclosure consists of or consists essentially of a corrosion inhibitor compound and an iron chelating agent.

Examples of corrosion inhibitor compounds include, but are not limited to, an organic sulfur compound, an imidazoline, a carboxylic acid-containing compound, a fatty acid amine condensate, a substituted fatty acid ester, a substituted aromatic amine, a phosphoric acid ester, a quaternary ammonium compound, or a compound comprising multiple positive charges.

In some embodiments, a composition disclosed herein comprises, consists of, or consists essentially of, an imidazoline compound, a quaternary amine, an iron chelating agent, and optionally a solvent.

The imidazoline compound may have formula (I), (II), or (III):

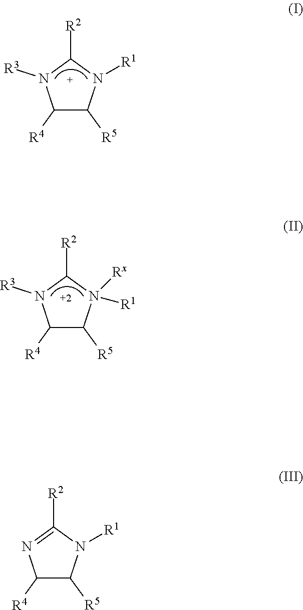

wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³);
R² is a radical derived from a fatty acid;
R³ and Rx are each independently selected from a radical derived from an unsaturated acid;
R⁶, R⁷, R⁸, R⁹, R¹⁰, and R¹¹ are each independently, at each occurrence, selected from hydrogen, alkyl, and alkenyl;
R¹² and R¹³ are each independently, at each occurrence, selected from hydrogen, alkyl, —COR¹⁴, —CO₂R¹⁵, -alkyl-COR¹⁶, and -alkyl-CO₂R¹⁷; and
R¹⁴, R¹⁵, R¹⁶, and R¹⁷ are each independently, at each occurrence, selected from hydrogen, alkyl, and alkenyl.

In the foregoing imidazolines, R groups of carboxylic acid moieties can be absent where the R═H and the carboxylic acid moiety is deprotonated. For example, R¹⁵ and/or R¹⁷ can be absent where the R¹² and/or R¹³ is a deprotonated carboxylic acid moiety (e.g., where R¹² is —CH₂CH₂CO₂—).

For an imidazoline compound, R¹ can be unsubstituted alkyl. For example, R¹ can be unsubstituted C₁-C₁₀-alkyl (e.g., methyl, ethyl, propyl (e.g., n-propyl, isopropyl), butyl (e.g., n-butyl, isobutyl, tert-butyl, sec-butyl), pentyl (e.g., n-pentyl, isopentyl, tert-pentyl, neopentyl, sec-pentyl, 3-pentyl), hexyl, heptyl, octyl, nonyl, or decyl). Further, R¹ can be unsubstituted C₂-C₁₀-alkyl. For the imidazoline compounds, R¹ can be unsubstituted C₂-C₈-alkyl. Further, R¹ can be unsubstituted C₂-C₆-alkyl. In some embodiments, R¹ is propyl, butyl, or hexyl.

In some embodiments, R¹ is a substituted alkyl. For example, R¹ may be a substituted C₁-C₁₀-alkyl, substituted C₂-C₁₀-alkyl, substituted C₂-C₈-alkyl, or substituted C₂-C₆-alkyl. Further, R¹ may be a C₁-C₁₀-alkyl, C₂-C₁₀-alkyl, C₂-C₈-alkyl, or C₂-C₆-alkyl, substituted with one substituent selected from —COR⁶, —CO₂R⁷, —SO₃R⁸, —PO₃H₂, —CON(R⁹)(R¹⁰), —OR¹¹, and —N(R¹²)(R¹³), wherein R⁶, R⁷, R⁸, R⁹, R¹⁰, R¹¹, R¹², and R¹³ are as defined above. More specifically, R¹ may be a C₂-C₆-alkyl, substituted with one substituent selected from —N(R¹²)(R¹³), wherein R¹² and R¹³ are each independently selected from hydrogen, alkyl, —COR¹⁴, —CO₂R¹⁵, -alkyl-COR¹⁶, and -alkyl-CO₂R¹⁷, wherein R¹⁴, R¹⁵, R¹⁶, and R¹⁷ are as defined above. Further, R¹ may be a C₂-C₆-alkyl, substituted with one substituent selected from —N(R¹²)(R¹³), wherein R¹² and R¹³ are each independently selected from hydrogen, C₂-C₆-alkyl, —COR¹⁴, —CO₂R¹⁵, —C₂-C₆-alkyl-COR¹⁶, and —C₂-C₆-alkyl-CO₂R¹⁷, wherein R¹⁴, R¹⁵, R¹⁶, and R¹⁷ are selected from hydrogen and C₁-C₃₄-alkyl. For these imidazolines, R¹ may be a linear C₂-C₆-alkyl, substituted with one substituent that is a terminal —N(R¹²)(R¹³), wherein R¹² and R¹³ are each independently selected from hydrogen, —COR¹⁴, —CO₂R¹⁵, —C₂-C₆-alkyl-COR¹⁶, and —C₂-C₆-alkyl-CO₂R¹⁷, wherein R¹⁴, R¹⁵, R¹⁶, and R¹⁷ are selected from hydrogen and C₁-C₃₄-alkyl. For example, R¹ may be a linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁. Further, R¹ may be a linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen.

For the imidazolines of formulae (I), (II), and (III), R² may be a C₄-C₃₄-alkyl or C₄-C₃₄-alkenyl. For example, R² may be a —(CH₂)₃CH₃; —(CH₂)₄CH₃; —(CH₂)₅CH₃; —(CH₂)₆CH₃; —(CH₂)₇CH₃; —(CH₂)₃CH₃; —(CH₂)₉CH₃; —(CH₂)₁₀CH₃; —(CH₂)₁₁CH₃; —(CH₂)₁₂CH₃; —(CH₂)₁₃CH₃; —(CH₂)₁₄CH₃; —(CH₂)₁₅CH₃; —(CH₂)₁₆CH₃; —(CH₂)₁₇CH₃; —(CH₂)₁₈CH₃; —(CH₂)₁₉CH₃; —(CH₂)₂₀CH₃; —(CH₂)₂₁CH₃; —(CH₂)₂₂CH₃; —(CH₂)₂₃CH₃; —(CH₂)₂₄CH₃; —(CH₂)₂₅CH₃; —(CH₂)₂₆CH₃; —(CH₂)₂₇CH₃; —(CH₂)₂₈CH₃; —(CH₂)₂₉CH₃; —(CH₂)₃₀CH₃; —(CH₂)₃₁CH₃; —(CH₂)₃₂CH₃; —(CH₂)₃₃CH₃; —(CH₂)₃₄CH₃; —(CH₂)₂CH═CHCH₂CH═CHCH₂CH═CHCH₂CH═CHCH₂CH═CH(CH₂)₄CH₃; —(CH₂)₂CH═CHCH₂CH═CHCH₂CH═CHCH₂CH═CHCH₂CH═CHCH₂CH═CHCH₂CH₃; —(CH₂)₃CH═CHCH₂CH═CHCH₂CH═CH(CH₂)₇CH₃; —(CH₂)₃CH═CHCH₂CH₂CH═CHCH₂CH═CH(CH₂)₄CH₃; —(CH₂)₃CH═CH(CH₂)₄CH═CHCH₂CH═CH(CH₂)₄CH₃; —(CH₂)₃CH═CHCH₂CH═CHCH₂CH═CHCH₂CH═CH(CH₂)₄CH₃; —(CH₂)₃CH═CHCH₂CH═CHCH₂CH═CHCH₂CH═CHCH₂CH═CHCH₂CH₃; —(CH₂)₃CH═CHCH═CHCH═CHCH═CHCH═CH(CH₂)₄CH₃; —(CH₂)₄CH═CH(CH₂)₃CH₃; —(CH₂)₄CH═CHCH₂CH═CHCH₂CH═CH(CH₂)₄CH₃; —(CH₂)₄CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CH(CH₂)₄CH₃; —(CH₂)₄CH═CHCH₂CH═CHCH₂CH═CHCH₂CH═CHCH₂CH═CHCH₂CH═CHCH₂CH₃; —(CH₂)₅CH═CHCH₂CH═CHCH₂CH═CHCH₂CH₃; —(CH₂)₅CH═CHCH₂CH═CHCH₂CH═CHCH₂CH═CH(CH₂)₄CH₃; —(CH₂)₅CH═CHCH₂CH═CHCH₂CH═CHCH₂CH═CHCH₂CH═CHCH₂CH₃; —(CH₂)₆CH═CHCH═CHCH═CH(CH₂)₄CH₃; —(CH₂)₆CH═CHCH₂CH═CHCH₂CH═CHCH₂CH═CH(CH₂)₄CH₃; —(CH₂)₇CH═CH(CH₂)₃CH₃; —(CH₂)₇CH═CH(CH₂)₅CH₃; —(CH₂)₇CH═CH(CH₂)₇CH₃; —(CH₂)₇CH═CHCH═CHCH═CH(CH₂)₃CH₃; —(CH₂)₇CH═CHCH═CH(CH₂)₅CH₃; —(CH₂)₇CH═CHCH₂CH═CH(CH₂)₄CH₃; —(CH₂)₇CH═CHCH₂CH═CH(CH₂)₄CH₃; —(CH₂)₇CH═CHCH═CHCH₂CH₂CH═CHCH₂CH₃; —(CH₂)₇CH═CHCH═CHCH═CHCH═CHCH₂CH₃; —(CH₂)₇CH═CHCH₂CH═CHCH₂CH═CHCH₂CH═CH(CH₂)₄CH₃; —(CH₂)₇CH═CHCH₂CH═CHCH₂CH═CHCH₂CH₃; —(CH₂)₇CH═CHCH₂CH═CHCH₂CH═CHCH₂CH═CHCH₂CH═CHCH₂CH₃; —(CH₂)₉CH═CH(CH₂)₅CH₃; —(CH₂)₉CH═CHCH₂CH═CH(CH₂)₄CH₃; —(CH₂)₉CH═CHCH₂CH═CHCH₂CH═CHCH₂CH₃; —(CH₂)₉CH═CH(CH₂)₇CH₃; —(CH₂)₁₁CH═CH(CH₂)₅CH₃; —(CH₂)₁₁CH═CH(CH₂)₇CH₃; —(CH₂)₁₁CH═CHCH₂CH═CH(CH₂)₄CH₃; or —(CH₂)₁₃CH═CH(CH₂)₇CH₃.

In some embodiments, R² may be a radical derived from a saturated or unsaturated fatty acid. Suitable saturated fatty acids include, but are not limited to, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, and hexatriacontylic acid. Suitable unsaturated fatty acids include, but are not limited to, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, hexadecatrienoic acid, stearidonic acid, eicosatrienoic acid, eicosatetraenoic acid, heneicosapentaenoic acid, clupanodonic acid, osbond acid, (9Z,12Z,15Z,18Z,21Z)-tetracosa-9,12,15,18,21-pentaenoic acid, nisinic acid, γ-linolenic acid, eicosadienoic acid, dihomo-γ-linolenic acid, docosadienoic acid, adrenic acid, tetracosatetraenoic acid, (6Z,9Z,12Z,15Z,18Z)-tetracosa-6,9,12,15,18-pentaenoic acid, (Z)-Eicos-11-enoic acid, mead acid, erucic acid, nervonic acid, rumenic acid, α-calendic acid, β-calendic acid, jacaric acid, α-eleostearic acid, β-eleostearic acid, catalpic acid, punicic acid, rumelenic acid, α-parinaric acid, β-parinaric acid, bosseopentaenoic acid, pinolenic acid, and podocarpic acid. In some embodiments, R² is derived from coconut oil, beef tallow, or tall oil fatty acids (TOFA).

In some embodiments, R³ may be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and alkyl, and wherein R^{e} is hydrogen (—H) or alkyl. For example, R³ may be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and C₁-C₆-alkyl, and wherein R^{e} is hydrogen (—H) or C₁-C₆-alkyl. Further, R³ may be —CH₂CH₂CO₂R^{e}, wherein R^{e} is hydrogen (—H) or C₁-C₆-alkyl. Additionally, R^{e} can be absent where the R³ is a deprotonated carboxylic acid moiety (e.g., where R³ is —CH₂CH₂CO₂—).

In accordance with certain embodiments of the present disclosure, R³ can be derived from an acrylic acid. Suitable acrylic acids include, but are not limited to, acrylic acid, methacrylic acid, 2-ethylacrylic acid, 2-propylacrylic acid, and 2-(trifluoromethyl)acrylic acid. For example, R³ can be derived from acrylic acid (H₂C═CHCO₂H).

Imidazolines of formulae (I), (II), or (III) may have R^{x} equal to —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and alkyl, and wherein R^{e} is hydrogen (—H) or alkyl. Further, R^{x} can be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and C₁-C₆-alkyl, and wherein R^{e} is hydrogen (—H) or C₁-C₆-alkyl. Additionally, R^{x} may be —CH₂CH₂CO₂R^{e}, wherein R^{e} is hydrogen (—H) or C₁-C₆-alkyl. Further, R^{e} can be absent where the R^{x} is a deprotonated carboxylic acid moiety (e.g., where R^{x} is —CH₂CH₂CO₂—).

For the imidazolines described herein, R^{x} can be derived from an acrylic acid. Suitable acrylic acids include, but are not limited to, acrylic acid, methacrylic acid, 2-ethylacrylic acid, 2-propylacrylic acid, and 2-(trifluoromethyl)acrylic acid. For example, R^{x} can be derived from acrylic acid (H₂C═CHCO₂H).

Imidazolines of formulae (I), (II), or (III) can have R⁴ and R⁵ each independently be an unsubstituted C₁-C₁₀-alkyl (e.g., methyl, ethyl, propyl (e.g., n-propyl, isopropyl), butyl (e.g., n-butyl, isobutyl, tert-butyl, sec-butyl), pentyl (e.g., n-pentyl, isopentyl, tert-pentyl, neopentyl, sec-pentyl, 3-pentyl), hexyl, heptyl, octyl, nonyl, or decyl) or hydrogen. Further, R⁴ and R⁵ can each independently be an unsubstituted C₁-C₆ alkyl group or hydrogen. In some embodiments, R⁴ and R⁵ are each hydrogen (—H).

Imidazolines of formulae (I), (II), or (III) can have R⁶, R⁷, R⁸, R⁹, R¹⁰, and R¹¹ each independently be, at each occurrence, selected from hydrogen, unsubstituted alkyl, and unsubstituted alkenyl. For example, R⁶, R⁷, R⁸, R⁹, R¹⁰, and R¹¹ can each independently be, at each occurrence, selected from hydrogen, unsubstituted C₁-C₃₄-alkyl, and unsubstituted C₂-C₃₄-alkenyl. Further, R⁶, R⁷, R⁸, R⁹, R¹⁰, and R¹¹ can each independently be, at each occurrence, selected from hydrogen, unsubstituted C₁-C₁₀-alkyl, and unsubstituted C₂-C₁₀-alkenyl.

Further, R⁶, R⁷, R⁸, R⁹, R¹⁰, and R¹¹ can each independently be, at each occurrence, selected from hydrogen, and a radical derived from a fatty acid.

R¹² and R¹³ can each independently be, at each occurrence, selected from hydrogen, C₁-C₁₀-alkyl, —COR¹⁴, —CO₂R¹⁵, —C₁-C₁₀-alkyl-COR¹⁶, and —C₁-C₁₀-alkyl-C O₂R¹⁷. Further, R¹² and R¹³ can each independently be, at each occurrence, selected from hydrogen, unsubstituted C₁-C₁₀-alkyl, —COR¹⁴, —CO₂R¹⁵, —C₁-C₁₀-alkyl-COR¹⁶, and —C₁-C₁₀-alkyl-CO₂R¹⁷.

R¹⁴, R¹⁵, R¹⁶, and R¹⁷ can each independently be, at each occurrence, selected from hydrogen, unsubstituted alkyl, and unsubstituted alkenyl. Further, R¹⁴, R¹⁵, R¹⁶, and R¹⁷ can each independently be, at each occurrence, selected from hydrogen, unsubstituted C₁-C₃₄-alkyl, and unsubstituted C₂-C₃₄-alkenyl. Additionally, R¹⁴, R¹⁵, R¹⁶, and R¹⁷ can each independently be, at each occurrence, selected from hydrogen, unsubstituted C₁-C₁-alkyl, and unsubstituted C₂-C₁₀-alkenyl. Further, R¹⁵ and/or R¹⁷ can be absent where the carboxylic acid moiety is deprotonated.

Imidazoline compounds of the present disclosure can have R¹⁴, R¹⁵, R¹⁶, and R¹⁷ each independently be, at each occurrence, selected from hydrogen, and a radical derived from a fatty acid. Further, R¹⁴, R¹⁵, R¹⁶, and R¹⁷ can each independently be, at each occurrence, selected from hydrogen, C₄-C₃₄-alkyl, and C₄-C₃₄-alkenyl. Additionally, R¹⁴, R¹⁵, R¹⁶, and R¹⁷ can each independently be, at each occurrence, selected from hydrogen; —(CH₂)₃CH₃; —(CH₂)₄CH₃; —(CH₂)₅CH₃; —(CH₂)₆CH₃; —(CH₂)₇CH₃; —(CH₂)₈CH₃; —(CH₂)₉CH₃; —(CH₂)₁₀CH₃; —(CH₂)₁₁CH₃; —(CH₂)₁₂CH₃; —(CH₂)₁₃CH₃; —(CH₂)₁₄CH₃; —(CH₂)₁₅CH₃; —(CH₂)₁₆CH₃; —(CH₂)₁₇CH₃; —(CH₂)₁₈CH₃; —(CH₂)₁₉CH₃; —(CH₂)₂₀CH₃; —(CH₂)₂₁CH₃; —(CH₂)₂₂CH₃; —(CH₂)₂₃CH₃; —(CH₂)₂₄CH₃; —(CH₂)₂₅CH₃; —(CH₂)₂₆CH₃; —(CH₂)₂₇CH₃; —(CH₂)₂₈CH₃; —(CH₂)₂₉CH₃; —(CH₂)₃OCH₃; —(CH₂)₃₁CH₃; —(CH₂)₃₂CH₃; —(CH₂)₃₃CH₃; —(CH₂)₃₄CH₃; —(CH₂)₂CH═CHCH₂CH═CHCH₂CH═CHCH₂CH═CHCH₂CH═CH(CH₂)₄CH₃; —(CH₂)₂CH═CHCH₂CH═CHCH₂CH═CHCH₂CH═CHCH₂CH═CHCH₂CH═CHCH₂CH₃; —(CH₂)₃CH═CHCH₂CH═CHCH₂CH═CH(CH₂)₇CH₃; —(CH₂)₃CH═CHCH₂CH₂CH═CHCH₂CH═CH(CH₂)₄CH₃; —(CH₂)₃CH═CH(CH₂)₄CH═CHCH₂CH═CH(CH₂)₄CH₃; —(CH₂)₃CH═CHCH₂CH═CHCH₂CH═CHCH₂CH═CH(CH₂)₄CH₃; —(CH₂)₃CH═CHCH₂CH═CHCH₂CH═CHCH₂CH═CHCH₂CH═CHCH₂CH₃; —(CH₂)₃CH═CHCH═CHCH═CHCH═CHCH═CH(CH₂)₄CH₃; —(CH₂)₄CH═CH(CH₂)₈CH₃; —(CH₂)₄CH═CHCH₂CH═CHCH₂CH═CH(CH₂)₄CH₃; —(CH₂)₄CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CHCH₂CH₃; —(CH₂)₄CH═CHCH₂CH═CHCH₂CH═CHCH₂CH═CHCH₂CH═CH(CH₂)₄CH₃; —(CH₂)₄CH═CHCH₂CH═CHCH₂CH═CHCH₂CH═CHCH₂CH═CHCH₂CH═CHCH₂CH₃; —(CH₂)₅CH═CHCH₂CH═CHCH₂CH═CHCH₂CH₃; —(CH₂)₅CH═CHCH₂CH═CHCH₂CH═CHCH₂CH═CH(CH₂)₄CH₃; —(CH₂)₅CH═CHCH₂CH═CHCH₂CH═CHCH₂CH═CHCH₂CH═CHCH₂CH₃; —(CH₂)₆CH═CHCH═CHCH═CH(CH₂)₄CH₃; —(CH₂)₆CH═CHCH₂CH═CHCH₂CH═CHCH₂CH═CH(CH₂)₄CH₃; —(CH₂)₇CH═CH(CH₂)₃CH₃; —(CH₂)₇CH═CH(CH₂)₅CH₃; —(CH₂)₇CH═CH(CH₂)₇CH₃; —(CH₂)₇CH═CHCH═CHCH═CH(CH₂)₃CH₃; —(CH₂)₇CH═CHCH═CH(CH₂)₅CH₃; —(CH₂)₇CH═CHCH₂CH═CH(CH₂)₄CH₃; —(CH₂)₇CH═CHCH₂CH═CH(CH₂)₄CH₃; —(CH₂)₇CH═CHCH═CHCH₂CH₂CH═CHCH₂CH₃; —(CH₂)₇CH═CHCH═CHCH═CHCH═CHCH₂CH₃; —(CH₂)₇CH═CHCH₂CH═CHCH₂CH═CHCH₂CH═CH(CH₂)₄CH₃; —(CH₂)₇CH═CHCH₂CH═CHCH₂CH═CHCH₂CH₃; —(CH₂)₇CH═CHCH₂CH═CHCH₂CH═CHCH₂CH═CHCH₂CH═CHCH₂CH₃; —(CH₂)₉CH═CH(CH₂)₅CH₃; —(CH₂)₉CH═CHCH₂CH═CH(CH₂)₄CH₃; —(CH₂)₉CH═CHCH₂CH═CHCH₂CH═CHCH₂CH₃; —(CH₂)₉CH═CH(CH₂)₇CH₃; —(CH₂)₁₁CH═CH(CH₂)₅CH₃; —(CH₂)₁₁CH═CH(CH₂)₇CH₃; —(CH₂)₁₁CH═CHCH₂CH═CH(CH₂)₄CH₃; and —(CH₂)₁₃CH═CH(CH₂)₇CH₃.

For the imidazolines of formulae (I), (II), and (III), R¹⁴, R¹⁵, R¹⁶, and R¹⁷ can each independently be, at each occurrence, selected from hydrogen, a radical derived from a saturated fatty acid, and a radical derived from an unsaturated fatty acid. Suitable saturated fatty acids include, but are not limited to, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, and hexatriacontylic acid. Suitable unsaturated fatty acids include, but are not limited to, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, hexadecatrienoic acid, stearidonic acid, eicosatrienoic acid, eicosatetraenoic acid, heneicosapentaenoic acid, clupanodonic acid, osbond acid, (9Z,12Z,15Z,18Z,21Z)-tetracosa-9,12,15,18,21-pentaenoic acid, nisinic acid, γ-linolenic acid, eicosadienoic acid, dihomo-γ-linolenic acid, docosadienoic acid, adrenic acid, tetracosatetraenoic acid, (6Z,9Z,12Z,15Z,18Z)-tetracosa-6,9,12,15,18-pentaenoic acid, (Z)-Eicos-11-enoic acid, mead acid, erucic acid, nervonic acid, rumenic acid, α-calendic acid, β-calendic acid, jacaric acid, α-eleostearic acid, β-eleostearic acid, catalpic acid, punicic acid, rumelenic acid, α-parinaric acid, β-parinaric acid, bosseopentaenoic acid, pinolenic acid, and podocarpic acid.

Further, R¹⁴, R¹⁵, R¹⁶, and R¹⁷ are each independently, at each occurrence, hydrogen or a radical derived from coconut oil, beef tallow, or tall oil fatty acids (TOFA).

In some embodiments, the imidazoline is a compound of formula (I), wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R⁴ is hydrogen; and R⁵ is hydrogen.

In some embodiments, the imidazoline is a compound of formula (I), wherein R¹ is linear C₂-alkyl, substituted with one substituent that is a terminal —N(R¹²)(R¹³), wherein R¹² is hydrogen and R¹³ is —COR¹⁴ wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R⁴ is hydrogen; and R⁵ is hydrogen.

In certain embodiments, the imidazoline is a compound of formula (I), wherein R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or is absent (e.g., R¹² is —C₂-alkyl-CO₂—); R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R⁴ is hydrogen; and R⁵ is hydrogen.

In some embodiments, the imidazoline is a compound of formula (II), wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂—); R⁴ is hydrogen; and R⁵ is hydrogen.

In some embodiments, the imidazoline is a compound of formula (II), wherein R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂—); R⁴ is hydrogen; and R⁵ is hydrogen.

In certain embodiments, the imidazoline can be a compound of formula (II), wherein R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or is absent (e.g., R¹² is —C₂-alkyl-CO₂—); R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂—); R⁴ is hydrogen; and R⁵ is hydrogen.

In some embodiments, the imidazoline can be a compound of formula (III), wherein R¹ is unsubstituted C₂-C₆-alkyl; R² is —C₁₇H₃₅, —C₁₇H₃₃, or —C₁₇H₃₁; R⁴ is hydrogen; and R⁵ is hydrogen.

In some embodiments, the imidazoline can be a compound of formula (III), wherein R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R⁴ is hydrogen; and R⁵ is hydrogen.

In certain embodiments, the imidazoline can be a compound of formula (III), wherein R¹ is linear C₂-alkyl, substituted with one substituent that is a terminal —N(R¹²)(R¹³), wherein R¹² and R¹³ are each a —C₂-alkyl-CO₂R¹⁷, wherein R¹⁷ is hydrogen or is absent (e.g., R¹² is —C₂-alkyl-CO₂—); R² is —C₁₇H₃₅, —C₁₇H₃₃, or —C₁₇H₃₁; R⁴ is hydrogen; and R⁵ is hydrogen.

It is to be understood, whether explicitly set forth or not, that formula (I), formula (II), and formula (III) are each intended to encompass the tautomeric, racemic, enantiomeric, diastereomeric, zwitterionic, and salt forms of said formulas. The imidazolines can exist in a zwitterionic form where R³ and/or R^{x} is derived from an acrylic acid.

In accordance with the present disclosure, the corrosion inhibitor compound may be a quaternary amine. Suitable quaternary amines include, but are not limited to, alkyl, hydroxyalkyl, alkylaryl, arylalkyl or arylamine quaternary salts.

Suitable alkyl, hydroxyalkyl, alkylaryl arylalkyl or arylamine quaternary salts include those alkylaryl, arylalkyl and arylamine quaternary salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I. For the quaternary amine, R^{5a}, R^{6a}, R^{7a}, and R^{8a} can each independently be selected from the group consisting of alkyl (e.g., C₁-C₁₈ alkyl), hydroxyalkyl (e.g., C₁-C₁₈ hydroxyalkyl), and arylalkyl (e.g., benzyl). The mono or polycyclic aromatic amine salt with an alkyl or alkylaryl halide include salts of the formula [N⁺R^{5a}R^{6a}R^{7a}R^{8a}][X⁻] wherein R^{5a}, R^{6a}, R^{7a}, and R^{8a} contain one to 18 carbon atoms, and X is Cl, Br or I.

Suitable quaternary ammonium salts include, but are not limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, hexadecyl trimethyl ammonium chloride, dimethyl alkyl benzyl quaternary ammonium compounds, monomethyl dialkyl benzyl quaternary ammonium compounds, trimethyl benzyl quaternary ammonium compounds, and trialkyl benzyl quaternary ammonium compounds, wherein the alkyl group can contain between about 1 and about 24 carbon atoms, about 10 and about 18 carbon atoms, or about 12 to about 16 carbon atoms, such as for example, C₁₂₋₁₆ benzyl dimethyl ammonium chloride. Suitable quaternary ammonium compounds (quats) include, but are not limited to, trialkyl, dialkyl, dialkoxy alkyl, monoalkoxy, benzyl, and imidazolinium quaternary ammonium compounds, salts thereof, the like, and combinations thereof. The quaternary ammonium salt can be an alkylamine benzyl quaternary ammonium salt, a benzyl triethanolamine quaternary ammonium salt, or a benzyl dimethylaminoethanolamine quaternary ammonium salt.

The quaternary amine can be a benzalkonium salt represented by the formula:

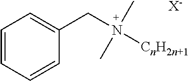

wherein n is 8, 10, 12, 14, 16, or 18; and X is Cl, Br or I.

The quaternary amine can be a mixture of benzalkonium salts wherein n is 8, 10, 12, 14, 16, and 18.

The quaternary amine can be a mixture of benzalkonium salts wherein n is 12, 14, 16, and 18.

The quaternary amine can be a mixture of benzalkonium salts wherein n is 12, 14, and 16.

The quaternary amine can be a mixture of benzalkonium salts wherein n is 12, 14, 16, and 18 and X is Cl.

The quaternary amine can be a mixture of benzalkonium salts wherein n is 12, 14, and 16, and X is Cl.

The quaternary amine can be an alkyl pyridinium quaternary salt such as those represented by the general formula:

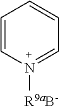

wherein R^{9a} is an alkyl group, an aryl group, or an arylalkyl group, wherein said alkyl groups have from 1 to about 18 carbon atoms and B is Cl, Br or I.

Among these compounds are alkyl pyridinium salts and alkyl pyridinium benzyl quats. Examples include methyl pyridinium chloride, ethyl pyridinium chloride, propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride. In some embodiments, the alkyl is a C₁-C₆ hydrocarbyl group.

The compositions disclosed herein include a phosphonium compound, such as a phosphonium salt. Suitable phosphonium salts include, but are not limited to, alkyltris(hydroxyorgano)phosphonium salts, alkenyltris(hydroxyorgano)phosphonium salts, and tetrakis(hydroxyorgano)phosphonium salts. The alkyltris(hydroxyorgano)phosphonium salts can be C₁-C₃-alkyltris(hydroxymethyl)phosphonium salts. The alkenyltris(hydroxyorgano)phosphonium salts can be C₂-C₃-alkenyltris(hydroxymethyl)phosphonium salts. The tetrakis(hydroxyorgano)phosphonium salts can be tetrakis(hydroxymethyl)phosphonium salts, including, but not limited to, tetrakis(hydroxymethyl)phosphonium sulphate (THPS), tetrakis(hydroxymethyl)phosphonium chloride, tetrakis(hydroxymethyl)phosphonium phosphate, tetrakis(hydroxymethyl)phosphonium formate, tetrakis(hydroxymethyl)phosphonium acetate, and tetrakis(hydroxymethyl)phosphonium oxalate. In some embodiments, the phosphonium salt is THPS.

The compound comprising multiple positive charges may be derived from a polyamine through its reactions with an activated olefin and an epoxide, wherein the activated olefin has the following formula:

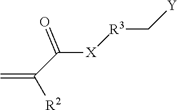

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; wherein the epoxide has the following formula;

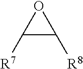

R⁷ is H or alkyl; and R⁸ is alkyl, or —(CH₂)ₖ-O-alkyl, wherein k is an integer of 1-30; wherein the polyamine and activated olefin undergo aza Michael Addition reaction and the polyamine and epoxide undergo ring opening reaction. In some embodiments, the compound comprises a nonionic group.

In some embodiments, the compound has one of the generic formula of NA₂-[R¹⁰′]ₙ-NA₂, (RNA)ₙ-RNA₂, NA₂-(RNA)ₙ-RNA₂, or NA₂-(RN(R′))ₙ-RNA₂, wherein R¹⁰′ is a linear or branched, unsubstituted or substituted C₂-C₁₀ alkylene group, or combination thereof; R is —CH₂—, —CH₂CH₂—, —CH₂CH₂CH₂—, —CH(CH₃)CH₂—, a linear or branched, unsubstituted or substituted C₄-C₁₀ alkylene group, or combination thereof; R′ is —CH₂—, —CH₂CH₂—, —CH₂CH₂CH₂—, —CH(CH₃)CH₂—, a linear or branched, unsubstituted or substituted C₄-C₁₀ alkyl group, RNAB, RNARNAB, or RN(RNAB)₂; n can be from 2 to 1,000,000; A is a combination of H,

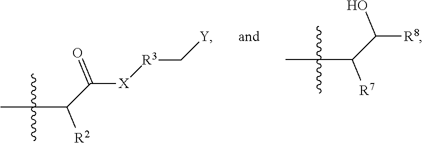

wherein X is NH or O; R² is H, CH₃, or an unsubstituted, linear or branched C₂-C₁₀ alkyl, alkenyl, or alkynyl group; R³ is absent or an unsubstituted, linear C₁-C₃₀ alkylene group; Y is —NR₄R₅R₆⁽⁺⁾; R⁴, R⁵, and R⁶ are independently a C₁-C₁₀ alkyl group; R⁷ is H or alkyl; and R⁸ is alkyl, or —(CH₂)ₖ-O-alkyl, wherein k is an integer of 1-30.

The compound may be a multiple charged cationic compound having a

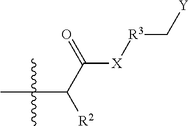

group and a

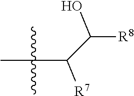

group.

In some aspects, the treatment chemical can be 2-mercaptoethanol, a diethylenetriamine (DETA): tall oil fatty acid (TOFA) imidazoline, a reaction product of trimethylamine (TEA) and TOFA, a reaction product of TOFA and tetraethylenepentamine (TEPA), an alkyl pyridine, an ethoxylated branched nonylphenol phosphate ester, a benzy-(C₁₂ to C₁₈ linear alkyl)-dimethylammonium chloride, 5-carboxy-4-hexyl-2-cyclohexene octanoic acid, 6-carboxy-4-hexyl-2-cyclohexene octanoic acid, maleated TOFA, an acrylated DETA:TOFA imidazoline, and any combination thereof.

In some embodiments, the corrosion inhibitor may be selected from, for example, benzyl ammonium chloride, acrylated imidazoline, 2-mercaptoethanol, a quaternary ammonium compound, a phosphate ester, a substituted aromatic amine, an alkyl pyridine, a fatty acid amine condensate, and any combination thereof.

The compositions disclosed herein also include an iron chelating agent. For example, the iron chelating agent may include nitrilotriacetic acid, tannic acid, ethylenediaminetetraacetic acid (EDTA), diethylenetriaminepentaacetic acid, triethylenetetraminehexaacetic acid, 1-hydroxyethylidene-1,1-diphosphonic acid (HEDP), or any combination thereof.

In some embodiments, the iron chelating agent may comprise an EDTA derivative, such as disodium EDTA, calcium disodium EDTA, a tetraammonium salt of EDTA, or any combination thereof.

The presently disclosed corrosion inhibitor compositions are useful for inhibiting corrosion of metal surfaces in contact with any type of corrodent in the medium, such as a metal cation, a metal complex, a metal chelate, an organometallic complex, an aluminum ion, an ammonium ion, a barium ion, a chromium ion, a cobalt ion, a cuprous ion, a cupric ion, a calcium ion, a ferrous ion, a ferric ion, a hydrogen ion, a magnesium ion, a manganese ion, a molybdenum ion, a nickel ion, a potassium ion, a sodium ion, a strontium ion, a titanium ion, a uranium ion, a vanadium ion, a zinc ion, a bromide ion, a carbonate ion, a chlorate ion, a chloride ion, a chlorite ion, a dithionate ion, a fluoride ion, a hypochlorite ion, an iodide ion, a nitrate ion, a nitrite ion, an oxide ion, a perchlorate ion, a peroxide ion, a phosphate ion, a phosphite ion, a sulfate ion, a sulfide ion, a sulfite ion, a hydrogen carbonate ion, a hydrogen phosphate ion, a hydrogen phosphite ion, a hydrogen sulfate ion, a hydrogen sulfite ion, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sulfur dioxide, hydrogen peroxide, a polysaccharide, a metal oxide, sand, a clay, silicon dioxide, titanium dioxide, mud, an insoluble inorganic and/or organic particulate, an oxidizing agent, a chelating agent, an alcohol, and any combination of the foregoing.

The presently disclosed corrosion inhibitor compositions are useful for inhibiting corrosion of surfaces comprising any metal or combination of metals. In some aspects, the metal surface comprises steel, such as stainless steel or carbon steel. In some aspects, the metal surface comprises iron, aluminum, zinc, chromium, manganese, nickel, tungsten, molybdenum, titanium, vanadium, cobalt, niobium, copper, or any combination thereof. The metal surface may also comprise boron, phosphorus, sulfur, silicon, oxygen, nitrogen, and any combination thereof. In some aspects, a pipe, such as a pipeline, or any component in fluid communication with the pipe comprises the metal surface.

The compositions of the present disclosure may comprise various amounts of the compounds/components disclosed herein, such as the corrosion inhibitor compound and the iron chelating agent.

For example, a composition may comprise from about 5 wt. % to about 95 wt. % of the corrosion inhibitor compound, such as from about 5 wt. % to about 85 wt. %, about 5 wt. % to about 75 wt. %, about 5 wt. % to about 65 wt. %, about 5 wt. % to about 55 wt. %, about 5 wt. % to about 45 wt. %, about 5 wt. % to about 35 wt. %, about 5 wt. % to about 25 wt. %, about 10 wt. % to about 20 wt. %, about 10 wt. % to about 30 wt. %, about 10 wt. % to about 40 wt. %, about 10 wt. % to about 50 wt. %, about 10 wt. % to about 60 wt. %, about 20 wt. % to about 60 wt. %, about 25 wt. % to about 55 wt. %, or about 30 wt. % to about 50 wt. % of the corrosion inhibitor compound.

Furthermore, a composition of the present disclosure may comprise from about 0.5 wt. % to about 50 wt. % of the iron chelating agent, such as from about 0.5 wt. % to about 40 wt. %, about 0.5 wt. % to about 30 wt. %, about 0.5 wt. % to about 20 wt. %, about 0.5 wt. % to about 10 wt. %, about 0.5 wt. % to about 5 wt. %, about 1 wt. % to about 10 wt. %, about 1 wt. % to about 20 wt. %, about 1 wt. % to about 30 wt. %, about 5 wt. % to about 25 wt. %, or about 10 wt. % to about 20 wt. % of the iron chelating agent. For example, the composition may include about 5 wt. %, about 7.5 wt. % about 10 wt. %, about 12 wt. %, or about 15 wt. % of the iron chelating agent.

In some embodiments, a composition may comprise from about 10 wt. % to about 50 wt. % of the corrosion inhibitor compound and from about 1 wt. % to about 20 wt. % of the iron chelating agent. In some embodiments, the composition comprises a greater weight percentage of the corrosion inhibitor compound than the iron chelating agent.

In certain embodiments, a composition comprises from about 30 wt. % to about 50 wt. % of the corrosion inhibitor compound and from about 1 wt. % to about 10 wt. % of the iron chelating agent.

The compositions of the present disclosure may comprise the corrosion inhibitor compound and the iron chelating agent in various weight ratios. For example, a composition may comprise a ratio of corrosion inhibitor compound to iron chelating agent of about 0.5:1 to about 50:1. In some embodiments, the weight ratio is about 0.5:1 to about 40:1, about 0.5:1 to about 30:1, about 0.5:1 to about 20:1, about 0.5:1 to about 10:1, about 0.5:1 to about 5:1, about 0.5:1 to about 1:1, about 1:1 to about 30:1, about 1:1 to about 20:1, about 1:1 to about 10:1, about 1:1 to about 5:1, about 2:1 to about 5:1, about 2:1 to about 10:1, about 2:1 to about 15:1, or from about 2:1 to about 20:1.

The compositions of the present disclosure may further comprise a solvent. Suitable solvents include, but are not limited to, an alcohol, a hydrocarbon, a ketone, an ether, an aromatic, an amide, a nitrile, a sulfoxide, an ester, a glycol ether, water, and combinations thereof.

For example, the solvent can be water, isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

Representative polar solvents suitable for formulation with the composition include water, brine, seawater, an alcohol (including straight chain or branched aliphatic, such as methanol, ethanol, propanol, isopropanol, butanol, 2-ethylhexanol, hexanol, octanol, decanol, 2-butoxyethanol, etc.), a glycol and a glycol derivative (e.g., ethylene glycol, 1,2-propylene glycol, 1,3-propylene glycol, ethylene glycol monobutyl ether, etc.), a ketone (such as cyclohexanone, diisobutylketone), N-methylpyrrolidinone (NMP), N,N-dimethylformamide, and the like.

Representative non-polar solvents suitable for formulation with the composition include an aliphatic, such as pentane, hexane, cyclohexane, methylcyclohexane, heptane, decane, dodecane, diesel, and the like; and an aromatic, such as toluene, xylene, heavy aromatic naphtha, a fatty acid derivative (e.g., an acid, an ester, an amide), and the like.

In some embodiments, the solvent is methanol, isopropanol, 2-ethylhexanol, or a combination thereof. In certain embodiments, the solvent is methanol, isopropanol, 2-ethylhexanol, water, or a combination thereof.

A composition of the present disclosure may include from about 0 wt. % to about 99 wt. % of the solvent, such as from about 5 wt. % to about 95 wt. %, about 5 wt. % to about 85 wt. %, about 5 wt. % to about 75 wt. %, about 5 wt. % to about 65 wt. %, about 5 wt. % to about 55 wt. %, about 5 wt. % to about 45 wt. %, about 5 wt. % to about 35 wt. %, about 5 wt. % to about 25 wt. %, about 5 wt. % to about 15 wt. %, about 15 wt. % to about 95 wt. %, about 25 wt. % to about 95 wt. %, about 35 wt. % to about 95 wt. %, about 40 wt. % to about 85 wt. %, or about 40 wt. % to about 80 wt. % of the solvent.

A composition of the present disclosure may comprise about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, or about 99 wt. % of the solvent.

Any composition disclosed herein may comprise (or exclude) an additional treatment chemical. In some embodiments, the treatment chemical is selected from the group consisting of a hydrate inhibitor, an asphaltene inhibitor, a paraffin inhibitor, a biocide, a scale inhibitor, and any combination thereof.

A hydrate inhibitor may include, for example, a mono-alkyl amide, a di-alkyl amide, an alkyl quaternary ammonium salt, and any combination thereof.

An asphaltene inhibitor may include, for example, an alkylphenol/formaldehyde resin, a polyisobutylene esters, a polyisobutylene imides, a polyalkyl acrylate, and any combination thereof.

A paraffin inhibitor may include, for example, a polyalkyl acrylate, an olefin/maleic anhydride polymer, and any combination thereof.

A biocide may include, for example, glutaraldehyde, tetrakis(hydroxymethyl)phosphonium sulphate, a quaternary ammonium compound, and any combination thereof.

A scale inhibitor may include, for example, a phosphonate, a sulfonate, a phosphate, a phosphate ester, a polymer comprising a phosphonate or phosphonate ester group, a polymeric organic acid, a peroxycarboxylic acid, and any combination thereof. In some embodiments, the scale inhibitor may be selected from a compound comprising an amine and/or a quaternary amine, nitrilotriacetic acid (NTA), ethylenediaminetetraacetic acid (EDTA), DETA phosphonate, and any combination thereof.

In some embodiments, the scale inhibitor is an acid-based scale inhibitor, such as phosphonic acid. In some embodiments, the scale inhibitor comprises an anionic group. The anionic group may comprise, for example, a carboxylate group or a sulfate group. In some embodiments, the scale inhibitor may include a phosphorous atom, a phosphorous-oxygen double bond, and/or a phosphono group.

In some embodiments, the scale inhibitor is selected from the group consisting of hexamethylene diamine tetrakis (methylene phosphonic acid), diethylene triamine tetra (methylene phosphonic acid), diethylene triamine penta (methylene phosphonic acid), polyacrylic acid (PAA), phosphino carboxylic acid (PPCA), diglycol amine phosphonate (DGA phosphonate), 1-hydroxyethylidene 1,1-diphosphonate (HEDP phosphonate), bisaminoethylether phosphonate (BAEE phosphonate), 2-acrylamido-2-methyl-1-propanesulphonic acid (AMPS), and any combination thereof.

In certain embodiments, the scale inhibitor is a polymer comprising an anionic monomer. The anionic monomer may be selected from, for example, acrylic acid, methacrylic acid, vinyl sulfonic acid, vinyl phosphonic acid, maleic anhydride, itaconic acid, crotonic acid, maleic acid, fumaric acid, styrene sulfonic acid, and any combination thereof.

In some embodiments, a composition disclosed herein may comprise (or exclude) an additional treatment chemical selected from a fouling control agent, a corrosion inhibitor intensifier, a biocide, a preservative, an acid, a hydrogen sulfide scavenger, a surfactant, an asphaltene inhibitor, a paraffin inhibitor, a scale inhibitor, a gas hydrate inhibitor, a pH modifier, an emulsion breaker, a reverse emulsion breaker, a coagulant/flocculant agent, an emulsifier, a water clarifier, a dispersant, an antioxidant, a polymer degradation prevention agent, a permeability modifier, a foaming agent, an antifoaming agent, a CO₂ scavenger, an O₂ scavenger, a gelling agent, a lubricant, a friction reducing agent, a salt, a clay stabilizer, a bactericide, a salt substitute, a relative permeability modifier, a breaker, a fluid loss control additive, an iron control agent, a drag reducing agent, a flow improver, a viscosity reducer, a solvent, and any combination thereof.

The fouling control agent may comprise, for example, a quaternary compound.

Illustrative, non-limiting examples of biocides include chlorine, hypochlorite, ClO₂, bromine, ozone, hydrogen peroxide, peracetic acid, peroxycarboxylic acid, peroxycarboxylic acid composition, peroxysulphate, glutaraldehyde, dibromonitrilopropionamide, isothiazolone, terbutylazine, polymeric biguanide, methylene bisthiocyanate, tetrakis hydroxymethyl phosphonium sulphate, and any combination thereof.

The acid may comprise, for example, hydrochloric acid, hydrofluoric acid, citric acid, formic acid, acetic acid, or any combination thereof.

The hydrogen sulfide scavenger may comprise, for example, an oxidant, inorganic peroxide, chlorine dioxide, a C-Cao aldehyde, formaldehyde, glyoxal, glutaraldehyde, acrolein, methacrolein, a triazine, or any combination thereof.

The composition may comprise, for example, from about 0 wt. % to about 90 wt. % of the additional treatment chemical. In some embodiments, the composition comprises from about 0.05 wt. % to about 80 wt. %, from about 0.05 wt. % to about 70 wt. %, from about 0.05 wt. % to about 60 wt. %, from about 0.05 wt. % to about 50 wt. %, from about 0.05 wt. % to about 40 wt. %, from about 0.05 wt. % to about 30 wt. %, from about 0.05 wt. % to about 20 wt. %, from about 0.05 wt. % to about 10 wt. %, from about 0.05 wt. % to about 1 wt. %, from about 1 wt. % to about 90 wt. %, from about 1 wt. % to about 75 wt. %, from about 1 wt. % to about 50 wt. %, from about 1 wt. % to about 25 wt. %, from about 1 wt. % to about 10 wt. %, from about 1 wt. % to about 5 wt. %, from about 10 wt. % to about 90 wt. %, from about 20 wt. % to about 90 wt. %, from about 30 wt. % to about 90 wt. %, from about 40 wt. % to about 90 wt. %, from about 50 wt. % to about 90 wt. %, from about 60 wt. % to about 90 wt. %, from about 70 wt. % to about 90 wt. %, or from about 80 wt. % to about 90 wt. % of the additional treatment chemical.

In some embodiments, the composition comprises, consists of, or consists essentially of a corrosion inhibitor compound and an iron chelating agent. In some embodiments, the composition comprises, consists of, or consists essentially of a corrosion inhibitor compound, an iron chelating agent, and an additional treatment chemical. In some embodiments, the composition comprises, consists of, or consists essentially of a corrosion inhibitor compound, a solvent, and an iron chelating agent. In some embodiments, the composition comprises, consists of, or consists essentially of a corrosion inhibitor compound, a solvent, an iron chelating agent, and an additional treatment chemical.

In certain aspects, a composition disclosed herein comprises from about 5 wt. % to about 10 wt. % of nitrilotriacetic acid, tannic acid, or a mixture thereof, from about 10 wt. % to about 50 wt. % of an imidazoline, such as tall oil fatty acid/diethylenetriamine imidazoline, and from about 40 wt. % to about 80 wt. % of xylene.

In accordance with certain aspects of the present disclosure, a composition disclosed herein may exclude a divalent metal ion. Adding a divalent metal ion in a method disclosed herein and/or adding a divalent metal ion to a composition disclosed herein could defeat an intended purpose of the disclosed technology. For example, in accordance with certain methods disclosed herein, an iron chelating agent is added to chelate divalent metals in the medium. Accordingly, adding additional divalent metals could frustrate the purpose of adding the iron chelating agent and create a scenario where additional amounts of iron chelating agent need to be added to chelate the divalent metals already in the medium.

The compositions disclosed herein can be used in any industry where it is desirable to inhibit corrosion. For example, a composition can be applied to a gas or liquid produced or used in the production, transportation, storage, and/or separation of crude oil or natural gas. A fluid to which the composition can be introduced may be an aqueous medium. The aqueous medium can comprise water, gas, and optionally liquid hydrocarbon. A fluid to which the compositions can be introduced may be a liquid hydrocarbon. The liquid hydrocarbon may be any type of liquid hydrocarbon including, but not limited to, crude oil, heavy oil, processed residual oil, bitminous oil, coker oils, coker gas oils, fluid catalytic cracker feeds, gas oil, naphtha, fluid catalytic cracking slurry, diesel fuel, fuel oil, jet fuel, gasoline, and kerosene. The fluid or gas may also be a refined hydrocarbon product.

A fluid or gas treated with a composition of the disclosure can be at any selected temperature, such as ambient temperature or an elevated temperature. For example, the fluid (e.g., water, liquid hydrocarbon, etc.) or gas can be at a temperature of from about 40° C. to about 250° C. In some embodiments, the fluid or gas can be at a temperature of from about −50° C. to about 300° C., about 0° C. to about 200° C., about 10° C. to about 100° C., or about 20° C. to about 90° C.

The compositions disclosed herein can be added to a fluid at various levels of water cut. For example, the water cut can be from about 0% to about 100% volume/volume (v/v), from about 1% to about 80% v/v, or from about 1% to about 60% v/v. The fluid can be an aqueous medium that contains various levels of salinity. For example, the fluid can have a salinity of about 0% to about 25%, about 1% to about 24%, or about 10% to about 25% weight/weight (w/w) total dissolved solids (TDS).

The fluid or gas in which the compositions of the disclosure are introduced can be contained in and/or exposed to many different types of apparatuses. For example, the fluid or gas can be contained in an apparatus that transports fluid or gas from one point to another, such as an oil and/or gas pipeline. The apparatus can be part of an oil and/or gas refinery, such as a pipeline, a separation vessel, a dehydration unit, or a gas line. The fluid can also be contained in and/or exposed to an apparatus used in oil extraction and/or production, such as a wellhead.

The compositions disclosed herein may be applied to a metallic surface using a variety of different application methods known in the art. In some embodiments, the compositions may be applied to the inner wall of a pipeline using a pig system. For example, a pig system may include a lead pig and a filming pig spaced apart axially from the lead pig to define an application storage space therebetween. The corrosion inhibitor composition may be located in the application storage space. Once both the lead pig and the filming pig are located in the pipeline, a force may be applied, for example, to the filming pig to move the lead pig and the filming pig in the lateral direction through the pipeline. In certain embodiments, the force is derived from a pressurized fluid, a mechanical actuator, a hydraulic actuator, an air compressor, or any combination thereof.

The lead pig may, for example, prepare the surface of the pipe by removing residue through mechanical scraping. As the filming pig travels behind the lead pig, it uniformly applies the composition in the application storage space to the interior surface of the pipe.

The outer diameter of the lead pig depends on the inner diameter of the pipeline. The outer diameter of the lead pig may be selected so that the lead pig properly engages the interior surface of the pipeline.

In some embodiments, the outer diameter of the lead pig may be greater than or about equal to the inner diameter of the pipeline. The lead pig may comprise a flexible material so that the outer diameter of the lead pig may be greater than the inner diameter of the pipeline.

In some embodiments, the outer diameter of the lead pig may be between about 1 inch and about 100 inches. In some embodiments, the outer diameter of the lead pig may be between about 1 inch and about 90 inches, about 1 inch and about 80 inches, about 1 inch and about 70 inches, about 1 inch and about 60 inches, about 1 inch and about 50 inches, about 1 inch and about 40 inches, about 1 inch and about 30 inches, about 1 inch and about 20 inches, about 1 inch and about 10 inches, about 5 inches and about 100 inches, about 10 inches and about 100 inches, about 20 inches and about 100 inches, about 30 inches and about 100 inches, about 40 inches and about 100 inches, about 50 inches and about 100 inches, about 60 inches and about 100 inches, about 70 inches and about 100 inches, about 80 inches and about 100 inches, or about 90 inches and about 100 inches.

The outer diameter of the filming pig may be greater than or about equal to the inner diameter of the pipeline. The filming pig may comprise a flexible material so that the outer diameter of the filming pig may be greater than the inner diameter of the pipeline. In this way, a better seal may be formed between the filming pig and the pipeline, thereby improving the application of the composition.

In some embodiments, the filming pig has an outer diameter about equal to the outer diameter of the lead pig. In other embodiments, the filming pig may have an outer diameter that is less than or greater than the outer diameter of the lead pig.

For example, the outer diameter of the filming pig may be between about 1 inch and about 100 inches, such as between about 1 inch and about 90 inches, about 1 inch and about 80 inches, about 1 inch and about 70 inches, about 1 inch and about 60 inches, about 1 inch and about 50 inches, about 1 inch and about 40 inches, about 1 inch and about 30 inches, about 1 inch and about 20 inches, about 1 inch and about 10 inches, about 5 inches and about 100 inches, about 10 inches and about 100 inches, about 20 inches and about 100 inches, about 30 inches and about 100 inches, about 40 inches and about 100 inches, about 50 inches and about 100 inches, about 60 inches and about 100 inches, about 70 inches and about 100 inches, about 80 inches and about 100 inches, or about 90 inches and about 100 inches.

A method of preparing a pipeline for application of an even layer of the composition to the interior surface of the pipeline may include several steps. For example, the method may include inserting the lead pig into the pipe and adding the composition to the pipe upstream of the lead pig. Next, the method includes inserting the filming pig into the pipe upstream of the composition such that the composition is located in the application storage space. Once the lead pig and the filming pig are in place, the method includes applying a force to the filming pig to cause the filming pig and the lead pig to move in the lateral direction through the pipeline. While traveling, the lead pig may clean an interior wall of the pipeline and the filming pig applies the composition to the interior wall of the pipeline.

The lead pig and the filming pig may be added or removed from the pipeline by any means known in the art. For example, the pipeline may have bypass sections, e.g. a pig launch and a pig receiver, in fluid communication with the main pipe in order to launch and receive the lead and filming pigs. The pig launcher may be used to launch the lead pig and the filming pig into the pipe, while the pig receiver may be used to receive the lead pig and the filming pig after moving through the pipeline.

The pig receiver may include a sensor configured to detect when the lead and filming pigs arrive at the pig receiver section of the pipeline. The pig receiver section may have different valves to control pressurization of the pipeline in order to safely remove the pigs from the pipeline. Once the pigs are removed, the valves may be reopened to return the system to the original condition.

In some embodiments, a subterranean formation and/or a pipeline comprises a metallic surface to be treated by a composition of the present disclosure. Certain methods disclosed herein comprise adding a composition disclosed herein to a medium, such as an aqueous medium, which comprises the metallic surface. Alternatively and/or additionally, the methods disclosed herein may comprise applying the composition directly to the metallic surface as opposed to, for example, adding to a liquid medium in contact with the metallic surface. In some embodiments, the composition may be applied to the interior wall of the pipeline when the interior wall is dry or substantially dry. In some embodiments, the pipeline is intended to transport a liquid medium/process fluid, such as an aqueous medium or a medium comprising aqueous and non-aqueous liquids (e.g., an aqueous/hydrocarbon mixture produced from a subterranean reservoir), and the composition is applied in the absence of the process fluid. The components of the process fluid may include, for example, water, hydrocarbons, brine, crude oil, refined oil, gas, liquefied natural gas, carbon dioxide, liquid hydrogen, and any combination thereof.

The present disclosure provides methods of inhibiting corrosion of a metallic surface in contact with a medium. The methods may comprise adding an effective amount of a composition to the medium, to the metallic surface, or any combination thereof, wherein the composition comprises, consists of, or consists essentially of a corrosion inhibitor compound and an iron chelating agent. The composition may be added continuously, intermittently, automatically, and/or manually. In some embodiments, the composition is applied batchwise, intermittently.

For example, the composition may be applied to an interior wall of a pipeline using a pig system. The application process may take place once per week, once per month, every other month, three times per year, five times per year, seven times per year, nine times per year, eleven times per year, or any appropriate number of times per year on an intermittent basis, as opposed to a continuous basis where corrosion inhibitor is continuously injected into the process fluid.

During application of the composition, a method disclosed herein may include reducing a flow rate of the process fluid within the pipeline while applying the composition. For example, the flow rate may be reduced by about 10% to about 75% of the standard operating flow rate. In some embodiments, the flow rate is reduced by about 15% to about 70%, about 20% to about 65%, about 25% to about 60%, or about 25% to about 50%.

The foregoing may be better understood by reference to the following examples, which are intended for illustrative purposes and are not intended to limit the scope of the disclosure or its application in any way.

### EXAMPLES

### Example 1

In a first series of experiments, the persistency of three compositions was assessed using a rotating cylinder electrode corrosion test with carbon dioxide saturated brine in which, after a period of corrosion under chemical-free conditions in a corrosive environment, the steel coupon was batch treated in either of the compositions and replaced back into the brine. About every 24 hours, the brine was replenished. The compositions were as follows:

Composition 1 (C1): about 50 wt. % TOFA:DETA imidazoline in a xylene solvent.

Composition 2 (C2): about 50 wt. % TOFA:DETA imidazoline, about 7.5 wt. % nitriloacetic acid, and the balance being xylene.

Composition 3 (C3): about 50 wt. % TOFA:DETA imidazoline, about 7.5 wt. % tannic acid, and the balance being xylene.

Testing was carried out with a carbon steel electrode (C1018 grade) and corrosion rates were assessed electrochemically using linear polarization resistance (LPR) methodology. Tests were carried out at about 60° C. with CO₂ saturated fluids with 3% NaCl brine without liquid hydrocarbon and with a continuous CO₂ sparge at atmospheric pressure.

The electrode was rotated with a wall shear stress of about 10 Pa. A pre-corrosion time (i.e., with no chemical inhibitor) was carried out for about 3 hours before a “dip and drip” batch treatment was performed wherein the coupon was dipped for about 5 seconds in either Composition 1, 2, or 3 and allowed to drip for about 10 seconds to allow for excess product to be removed. After about 24 hours, the brine was replaced with fresh brine. The brine was replaced again after about 48 hours and after about 72 hours. Results are shown in Table 1 below.

TABLE 1

| | Corrosion | | | | | | | | |
|---|---|---|---|---|---|---|---|---|---|
| | Rate After | Corrosion | | | | | | | |
| | 3 h of | Rate 15 h | % | Corrosion | % | | % | | % |
| | pre-corrosion | After | Protection | Rate 15 h | Protection | Corrosion | Protection | Corrosion | Protection |
| | without | Batch | 15 h After | After First | 15 h After | Rate 15 h | 15 h After | Rate 40 h | 40 h After |
| | batch | Treatment | Batch | Fluid | First | After Second | Second | After Third | Third |
| | inhibitor | of B1 | Treatment | Exchange | Fluid | Fluid Exchange | Fluid | Fluid Exchange | Fluid |
| | (mpy) | (mpy) | of BI | (mpy) | Exchange | (mpy) | Exchange | (mpy) | Exchange |
| Blank | 284 | 488 | N/A | 575 | N/A | 575 | N/A | 575 | N/A |
| C1 | 310 | 3 | 99 | 74 | 87 | 296 | 49 | 444 | 23 |
| C2 | 323 | 6 | 99 | 1.16 | 100 | 11.6 | 98 | 15.2 | 97 |
| C3 | 304 | 16 | 97 | 5.79 | 99 | 0.7 | 100 | 0.8 | 100 |

As can be seen, batch treatment of the corrosion inhibitor with about 7.5 wt. % of an iron chelating agent (Compositions 2 and 3) demonstrated significantly improved persistency and performance compared with the same corrosion inhibitor without the iron chelating agent (Composition 1). Furthermore, as further supported below, batch treatment of the corrosion inhibitor with iron chelating agent showed significantly improved persistency and performance as compared to continuous treatment with the same corrosion inhibitor and iron chelating agent.

In another set of experiments, the same chemistries as above were dosed at about 1,000 ppm as a continuous injection. This is a relatively high dose for typical continuous corrosion inhibitors but was selected for comparative purposes to the batch treatment directly applied to the metal surface. Apart from the application (about 1,000 ppm injection versus batch treatment), all other conditions were the same as the previous testing. When comparing the results, which are shown below in Table 2, to the results shown in Table 1, the persistency is diminished.

TABLE 2

| | Corrosion | | | | | | | | |
|---|---|---|---|---|---|---|---|---|---|
| | Rate After | | | | | | | | |
| | 3 h of | Corrosion | % | Corrosion | % | | % | | % |
| | pre-corrosion | Rate 15 h | Protection | Rate 15 h | Protection | Corrosion | Protection | Corrosion | Protection |
| | without | After | 15 h After | After First | 15 h After | Rate 15 h | 15 h After | Rate 15 h | 15 h After |
| Lab | batch | 1,000 ppm | 1,000 ppm | Fluid | First | After Second | Second | After Third | Third |
| Book | inhibitor | Injected | Injected | Exchange | Fluid | Fluid Exchange | Fluid | Fluid Exchange | Fluid |
| Number | (mpy) | (mpy) | (mpy) | (mpy) | Exchange | (mpy) | Exchange | (mpy) | Exchange |
| Blank | 284 | 488 | N/A | 575 | N/A | 575 | N/A | 575 | N/A |
| C2 | 336 | 11 | 98 | 40.62 | 93 | 145 | 75 | 383.5 | 33 |
| C3 | 293 | 19 | 96 | 126.6 | 78 | 152.5 | 73 | 169.5 | 71 |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a corrosion inhibitor” is intended to include “at least one corrosion inhibitor” or “one or more corrosion inhibitors.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion of a metal surface, comprising:
intermittently applying a composition to the metal surface, wherein the composition comprises a corrosion inhibitor compound and an iron chelating agent.

2. The method of claim 1, wherein a pipeline comprises the metal surface.

3. The method of claim 2, further comprising reducing a flow rate of a process fluid within the pipeline while applying the composition.

4. The method of claim 3, wherein the flow rate is reduced by about 10% to about 75%.

5. The method of claim 2, wherein the pipeline comprises a lead pig and a filming pig.

6. The method of claim 5, wherein the composition is applied to the metal surface between the lead pig and the filming pig.

7. The method of claim 5, wherein an outer diameter of the lead pig is about 3% to about 10% greater than an inner diameter of the pipeline.

8. The method of claim 5, wherein an outer diameter of the filming pig is about 1% to about 5% greater than an inner diameter of the pipeline.

9. The method of claim 1, wherein the composition comprises from about 0.5 wt. % to about 50 wt. % of the iron chelating agent.

10. The method of claim 1, wherein the composition comprises from about 5 wt. % to about 95 wt. % of the corrosion inhibitor.

11. The method of claim 1, wherein the composition comprises a weight ratio of the corrosion inhibitor to the iron chelating agent of about 0.5:1 to about 50:1.

12. The method of claim 1, wherein the composition is applied directly to the metal surface in the absence of an aqueous medium.

13. The method of claim 1, wherein the composition excludes a divalent metal ion.

14. The method of claim 1, wherein the composition is applied at an interval between about once per week and once per year.

15. The method of claim 1, wherein the corrosion inhibitor comprises a quaternary amine compound and/or an imidazoline compound.

16. The method of claim 15, wherein the imidazoline compound comprises formula (I), (II), or (III): 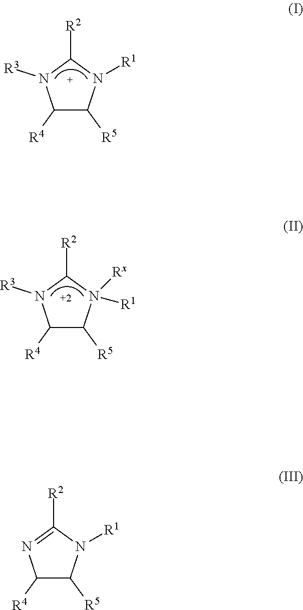
wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³);
R² is a radical derived from a fatty acid;
R³ and R^{x} are each independently selected from a radical derived from an unsaturated acid;
R⁶, R⁷, R⁸, R⁹, R¹⁰, and R¹¹ are each independently, at each occurrence, selected from hydrogen, alkyl, and alkenyl;
R¹² and R¹³ are each independently, at each occurrence, selected from hydrogen, alkyl, —COR¹⁴, —CO₂R¹⁵, -alkyl-COR¹⁶, and -alkyl-CO₂R¹⁷; and
R¹⁴, R¹⁵, R¹⁶, and R¹⁷ are each independently, at each occurrence, selected from hydrogen, alkyl, and alkenyl.

17. The method of claim 15, wherein the quaternary amine compound is an alkyl quaternary salt, a hydroxyalkyl quaternary salt, an alkylaryl quaternary salt, an arylalkyl quaternary salt or an arylamine quaternary salt.

18. The method of claim 1, wherein the composition further comprises a solvent selected from the group consisting of an alcohol, a hydrocarbon, a ketone, an ether, an aromatic, an amide, a nitrile, a sulfoxide, an ester, a glycol ether, water, and any combination thereof.

19. The method of claim 1, wherein the iron chelating agent is selected from the group consisting of nitrilotriacetic acid, tannic acid, ethylenediaminetetraacetic acid (EDTA), diethylenetriaminepentaacetic acid, triethylenetetraminehexaacetic acid, 1-Hydroxyethylidene-1,1-diphosphonic acid (HEDP), and any combination thereof.

20. The method of claim 1, wherein the composition comprises from about 5 wt. % to about 10 wt. % of nitrilotriacetic acid, tannic acid, or a mixture thereof, from about 10 wt. % to about 50 wt. % of a blend comprising about 50% tall oil fatty acid/diethylenetriamine imidazoline, and from about 40 wt. % to about 80 wt. % of xylene.
